(19) United States
(12) Patent Application Publication
(10) Pub. No.: US 2011/0310631 A1
(43) Pub. Date: Dec. 22, 2011

(54) LED HEADLAMP COOLING SYSTEM

(75) Inventor: Terry G. Davis, Kimball, MI (US)

(73) Assignee: Bayer MaterialScience LLC, Pittsburgh, PA (US)

(21) Appl. No.: 13/160,693

(22) Filed: Jun. 15, 2011

Related U.S. Application Data
(60) Provisional application No. 61/357,197, filed on Jun. 22, 2010.

(51) Int. Cl. F21V 29/02; B60Q 1/04

(52) U.S. Cl. 362/547

(57) ABSTRACT

The present invention provides improved LED headlamp cooling systems. The present invention allows for heat removal and recirculation of the excess heat into a forward lamp chamber of a head lamp before being exhausted out of the head lamp assembly.

### FIELD OF THE INVENTION

The present invention relates in general to, cooling systems and more specifically to, an LED headlamp cooling system.

### BACKGROUND OF THE INVENTION

LED head lamps have a problem with the excessive heat produced by the LED electronics. The high heat in the circuit board area of the head lamp assembly can significantly shorten the life of the electronic components. There are a number of patents in the field of headlamp thermal management.

For example, Dakin in U.S. Pat. No. 5,128,589 provides a heat transfer means to remove heat from a fused quartz arc tube being employed as the light source in an electric discharge lamp. The heat removal is carried out during lamp operation with a fused quartz protuberance that cooperates to remove heat being conducted through the arc tube walls. Various lamp embodiments are disclosed whereby such fused quartz protuberance is physically disposed adjacent the hot spot region of the arc tube in a xenon-metal halide lamp.

U.S. Pat. No. 5,993,035, issued to May et al., describes a combined light shield and heat shield for headlight, one embodiment of which comprises a light shield having a hollow cup-like configuration having an open-end and a closed end having a hollow open-end heat shield nested or positioned there within and separated therefrom by an open air gap disposed thereabout such that light rays emitted from a heat and light emitting source are able to pass through heat shield and impact and upon closed end of light shield to reduce glare to a viewer while being cooled by the heat sink provided by heat shield. In another embodiment, a hollow heat shield having an open-end and a closed end is supported within light shield such that the light rays from the heat and light emitting source impact upon closed end of heat shield rather than closed end of light shield.

U.S. Pat. No. 6,513,956, issued to Schaefer et al., discloses a lamp housing assembly which includes a lamp housing and a shield. The shield includes a first portion which extends into the cavity of the lamp housing and a second portion which extends out of the lamp housing. The first portion extends to a blocking end adapted to be positioned adjacent to a lamp disposed within the lamp housing cavity. The second portion includes an attachment end coupled to the lamp housing external of the lamp housing cavity.

Gelfand et al., in U.S. Pat. No. 6,663,264, provide a lamp assembly having a lamp housing defining a cavity with at least one side. The at least one side has vent passage. A heat shield is coupled to at least one side and at least partially aligned with the vent passage to provide ventilation to the lamp housing.

EP 484117 in the name of Dever et al., discloses a heat sink means for a metal halide lamp to enable more light output during lamp start-up. A xenon-metal halide lamp employing the heat sink means is disclosed along with an automotive headlamp having this lamp for its light source.

A need continues to exist in the art for improved LED headlamp cooling systems.

### SUMMARY OF THE INVENTION

Accordingly, the present invention provides-improved LED headlamp cooling systems. The present invention allows for heat removal and recirculation of the excess heat into a forward lamp chamber of a head lamp before being exhausted out of the head lamp assembly.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a horizontal fan and heat sink;

FIG. 2 illustrates a vertical fan and heat sink; and

FIG. 3 shows an intake off of an engine block.

### DETAILED DESCRIPTION OF THE INVENTION

The present invention will now be described for purposes of illustration and not limitation.

As shown in the Figures, the present invention permits heat removal and recirculation of excess heat into the forward lamp chamber of the head lamp before being exhausted out of the head lamp assembly. The present invention may use a combination of a fan system and natural convection as well as the venturi effect to circulate and exhaust the air from the head lamp assembly.

Recirculation is vital to the invention so as to allow the lamp chamber to become hot enough to evaporate any moisture that can collect in the head lamp. In current head lamps, the most significant heating occurs in the lamp chamber as a result of the thermal energy from the bulb. This energy creates enough heat in the bulb chamber to evaporate any condensation and clear the chamber of moisture.

In the LED headlamp, the bulb chamber frequently does not become hot enough to evaporate moisture. Recirculation of the heated air from the electronics chamber through the bulb chamber can provide heat for evaporation of moisture before the heated air is exhausted out of the headlamp.

The present invention uses the heat from the LED electronics to avoid fogging of the lens before the heat is exhausted from the assembly.

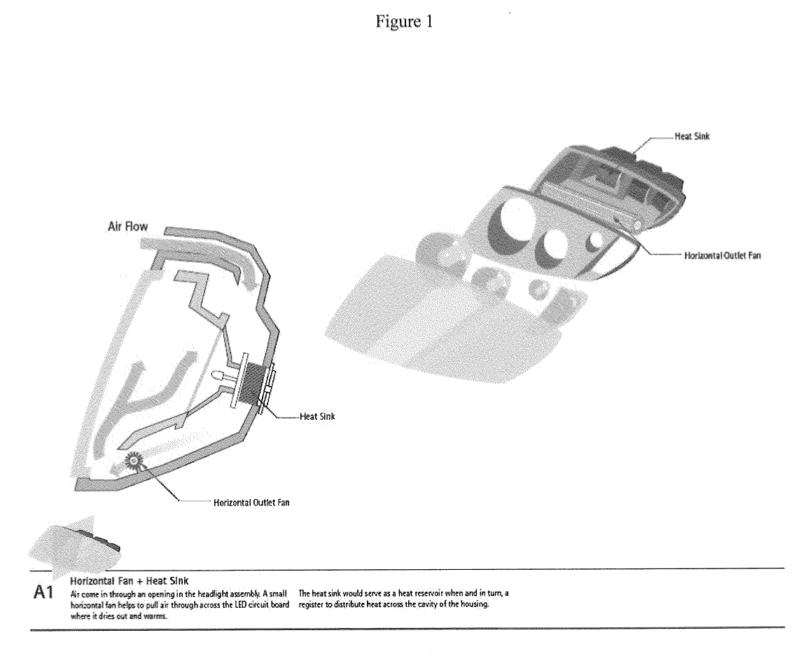

FIG. 1 shows a horizontal fan and a heat sink in which air enters through an opening in the headlight assembly. A small horizontal fan helps to draw air through and across an LED circuit board where the air dries and warms. The heat sink serves as a heat reservoir and also distributes heat across the cavity of the housing. The powered fan draws air which has been heated by the LED electronics through the lens to greatly reduce or eliminate condensation and then exhausts the air out of the lamp.

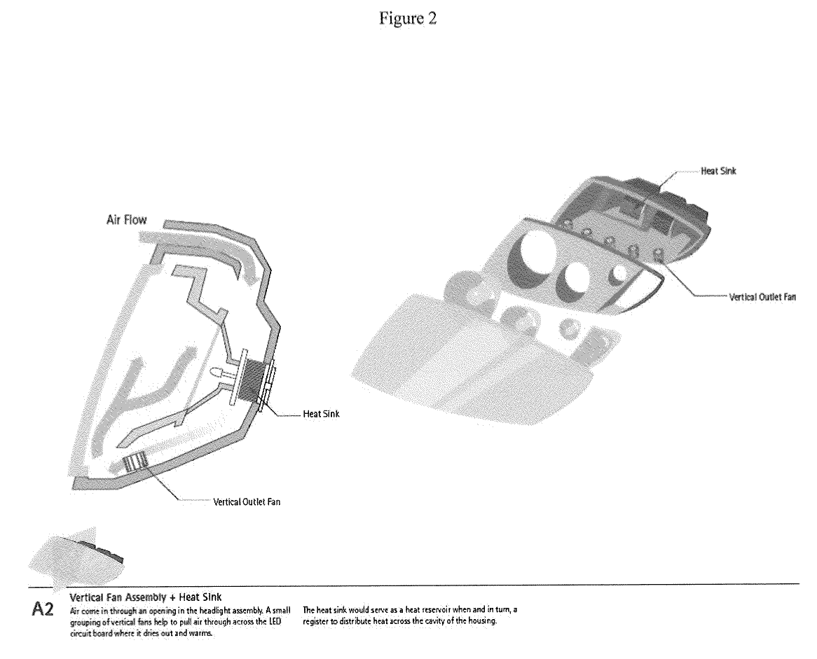

FIG. 2 shows a vertical fan and a heat sink in which air enters through an opening in the headlight assembly. A small group of vertical fans helps to draw air through and across the LED circuit board where it dries and warms. The heat sink serves as a heat reservoir and also distributes heat across the cavity of the housing.

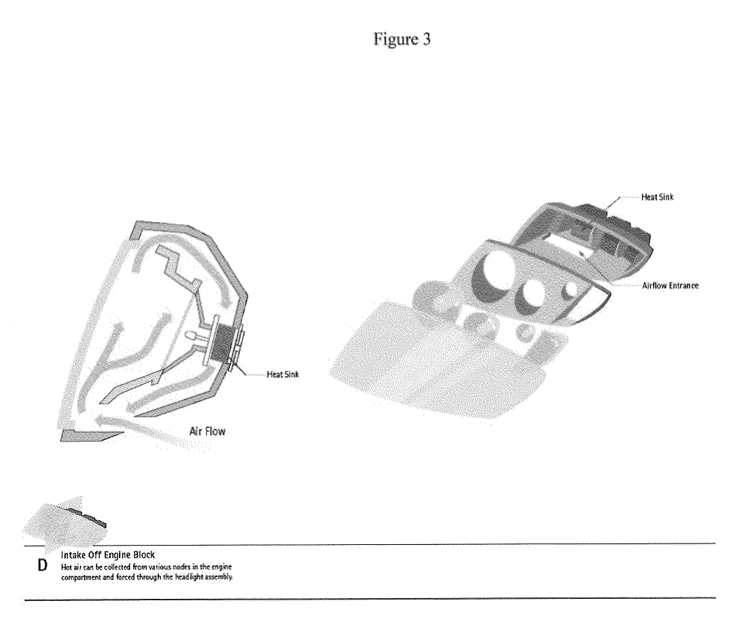

FIG. 3 shows an intake off of an engine block. Hot air may be collected from various nodes in the engine compartment and exhausted through the headlamp assembly to greatly reduce or eliminate condensation.

The foregoing description of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A light emitting diode (LED) headlamp cooling system comprising
a heat sink; and
a fan,
wherein the fan draws air through the headlamp over LED electronics to a lamp lens and exhausts the air from the lamp lens.
